(19) United States
(12) Patent Application Publication
(10) Pub. No.: US 2014/0230909 A1
(43) Pub. Date: Aug. 21, 2014

(54) DEVICES AND METHODS FOR PROGRAMMING FLUID FLOW USING SEQUENCED MICROSTRUCTURES

(71) Applicant: THE REGENTS OF THE UNIVERSITY OF CALIFORNIA, Oakland, CA (US)

(72) Inventors: Dino Di Carlo, Los Angeles, CA (US); Hamed Amini, Beverly Hills, CA (US); Elodie Sollier, Gagny (FR)

(21) Appl. No.: 14/347,047

(22) PCT Filed: Sep. 27, 2012
(86) PCT No.: PCT/US2012/057641

§ 371 Date: Mar. 25, 2014

Related U.S. Application Data
(60) Provisional application No. 61/541,953, filed on Sep. 30, 2011.

(51) Int. Cl. F15D 1/14

(52) U.S. Cl. CPC F15D 1/14
USPC 137/2; 137/628

(57) ABSTRACT

A microfluidic platform is disclosed that uses obstacles placed at particular location(s) within the channel cross-section to turn and stretch fluid. The asymmetric flow behavior upstream and downstream of the obstacle(s) due to fluid inertia manifests itself as a total deformation of the topology of streamlines that effectively creates a tunable net secondary flow. The system and methods passively creates strong secondary flows at moderate to high flow rates in microchannels. These flows can be accurately controlled by the numbers and particular geometric placement of the obstacle(s) within the channel.

### RELATED APPLICATION

This application claims priority to U.S. Provisional Patent Application No. 61/541,953, filed on Sep. 30, 2011, which is hereby incorporated by reference in its entirety. Priority is claimed pursuant to 35 U.S.C. §119.

### FIELD OF THE INVENTION

The field of the invention generally relates to microfluidic devices used for altering fluid flow. More particularly, the field of the invention relates to the microfluidic devices containing one or more microfluidic features therein to modify or alter fluid or particle flow therein.

### BACKGROUND

Flow control and fluid interface manipulation in microfluidic platforms is of great importance in a variety of applications. For example, fluid control can be employed to focus fluids or entrain particles at certain lateral positions within a microfluidic channel. Flow control can also be used to mix and even separate fluid components. Control of fluid streams is also useful in biological processing and chemical reaction control. Current approaches to manipulate fluids generally rely on complex designs or difficult to fabricate three-dimensional (3D) platforms. Still other microfluidic platforms require the incorporation of active elements. In addition, existing state-of-the art devices operate with the mind set of inducing chaos to enhance mixing at the microscale level. Consequently, these approaches essentially operate to induce disorder into the flow system which can lead to unpredictable flow control.

### SUMMARY

In one aspect of the invention, a microfluidic platform or device is disclosed that uses obstacles placed at particular location(s) within the channel cross-section to turn and stretch fluid in a manner that, unlike under Stokes flow conditions, does not precisely reverse after passing the obstacle(s). The asymmetric flow behavior upstream and downstream of the obstacle due to fluid inertia manifests itself as a total deformation of the topology of streamlines that effectively creates a tunable net secondary flow which in some ways resembles the recirculating Dean flow in curving channels. The system and methods passively creates strong secondary flows at moderate to high flow rates in microchannels. These flows can be accurately controlled by the number and particular geometric placement of the obstacle(s) within the channel. The fluid motions within the channels can be predicted and numerically simulated to characterize secondary fluid flow and predict net inertial flow deformations so that particular fluid patterns can be engineered in the channel cross-section.

Sequences of these obstacles can be assembled in series or in parallel within a channel to conduct additional fluidic operation on flowing fluid streams. Importantly, the secondary transport shape and magnitude remains relatively constant after passing an obstacle for over an order of magnitude of Reynolds numbers (or flow rates) enabling the prediction of the programmed flow field based on one mapping of transport after passing an obstacle without having to simulate each new configuration. In this regard, because of their deterministic nature, different sequences of obstacles can be used to “program” specific microfluidic flow stream patterns or shapes.

This system and method creates the possibility of exceptional control of the three-dimensional structure of the fluid within a microfluidic platform which can significantly advance applications requiring fluid interface control (e.g., optofluidics) or generation of gradients of molecules. Specific tailoring of fluid flow within a microfluidic channel can also be used to manufacture filaments or particles having specific cross-sectional dimensions. The microfluidic platform can also be used to provide for ultra-fast mixing or heat transfer. Microfluidic flows can be tailored for fluid exchange applications (i.e., exchanging fluid around cells or the like). Additional, selective separation of particles can be conducted due to the secondary flow interacting with the underlying inertial lift forces acting on the particles.

Rather than apply flow transformations that prevent or disrupt order, the flow control method and platform described herein is needed to program fluid flow based on the deterministic behavior of fluids interacting with objects contained with a microfluidic environment. A hierarchical approach is taken to engineer fluid streams into a broad class of complex configurations. The inertial flow deformations associated with the flow around a library of single fundamental operations (e.g., flow around a sequence of pillars) can act as the basic programming operators. Since these transformations provide a deterministic mapping of fluid elements from upstream to downstream of an obstacle, one can sequentially arrange obstacles to apply the associated nested maps and therefore program complex fluid structures without additional numerical simulation. Consequently, functions composed of multiple operators (e.g., posts, pillars, or other protuberances) such as ‘rotate stream to centerline’, or ‘move stream right’, can be hierarchically assembled to execute practical programs.

The cross-sectional shape of a stream can be sculpted into complex geometries (such as various concavity polygons, closed rings, and inclined lines), moved and split, rapidly mixed, shaped to form complex gradients, or tuned to transfer particles from a stream, and separate particles by size. The introduction of a general strategy to program fluid streams in which the complexity of the nonlinear equations of fluid motion are abstracted from the user can impact biological, chemical and materials automation in a similar way that abstraction of semiconductor physics from computer programmers enabled a revolution in computation.

In one embodiment of the invention, a method of programming flow within a channel includes selecting a plurality of operators from a library, each of the plurality of operators from the library having a known net secondary fluid affect; creating a program from the plurality of selected operators; and manufacturing a channel having formed therein the program of selected operators.

In another embodiment, a device includes a channel having at least one intersecting sheath fluid channel at an upstream location; and a plurality of different operators disposed within the channel at a downstream location, each operator comprising one or more protuberances having a known net secondary fluid affect, each of the plurality of operators being separated from one another along a length of the channel.

In another embodiment, a method of exchanging fluids around particles within a channel includes initiating sheath flow within a channel, wherein the particles are contained in a carrier fluid and absent from a sheathing fluid. The particles are passed through a program comprising a plurality of operators disposed within the channel configured to alter the flow around the particles such that the particles are contained within the sheathing fluid and not contained in the carrier fluid.

In another embodiment, a method of forming a filament using a channel includes: initiating sheath flow within a channel of a precursor material; passing the precursor material through a program comprising a plurality of pillar operators disposed within the channel configured to alter the cross-sectional profile of the flow in a pre-determined manner; and polymerizing the precursor material into a filament within the fluidic channel.

In another embodiment, a method of forming three-dimensional particles using a channel includes initiating sheath flow within a channel of a precursor material; passing the precursor material through a program comprising a plurality of pillar operators disposed within the channel configured to alter the cross-sectional profile of the flow in a pre-determined manner; and polymerizing the precursor material into particles within the channel by exposing a portion of the precursor material to light through a mask interposed between the channel and a light source.

In yet another embodiment, a method of heat transfer using a channel having one or more hot regions adjacent to a surface thereof includes initiating flow within a channel, wherein the flow includes one or more streams therein having a lower temperature; and passing the flow through a program comprising a plurality of operators disposed within the channel configured to alter the cross-sectional profile of the flow so as to move the one or more streams having the lower temperature adjacent to the one or more hot regions.

In still another embodiment a method of exposing target species to a reaction surface located on a surface of a channel includes initiating flow within a channel, the flow containing targets therein; and passing the flow through a program comprising a plurality of operators disposed within the channel configured to alter the cross-sectional profile of the flow so as to move the targets adjacent to the reaction surface.

In another embodiment, a method of generating or altering the gradient of one or more species in a fluid within a channel includes maintaining flow within a channel, the flow containing a fluid having an initial concentration profile of the one or more species in a cross sectional direction; and passing the flow through a program comprising a plurality of operators disposed within the channel configured to alter the cross-sectional profile of the flow so as to alter the concentration profile of the one or more species in the cross sectional direction.

### BRIEF DESCRIPTION OF THE DRAWINGS

FIG. 1A schematically illustrates four different microchannels having different operator configurations.

FIG. 1B graphically illustrates a library containing multiple operator configurations.

FIG. 1C illustrates an exemplary program that includes multiple operators. The combination of operators 1 and 2 rotate fluid while the combination of operators 3 and 1 move the stream to the right.

FIG. 2A illustrates a method of generating a library as well as selecting operators from the library to create a program sequence that can then be made into a microfluidic device.

FIG. 2B schematically represents how a final flow state F(s) is achieved by selecting different operator functions based on an initial condition S. In this example, a program is illustrated that uses three operator functions (f₁, f₂, f₃) in four, serially processed, logical steps.

FIG. 3A illustrates the flow in a microfluidic channel that passes a plurality of microstructures in the form of posts or pillars. The arrow plot shows the average lateral velocity field as fluid parcels travel from input cross-section (upstream) to output cross-section (downstream). FIG. 3A also illustrates a cross-sectional image of fluid flowing through the microfluidic channel at the inlet, after ten (10) pillars, after twenty (20) pillars, and after thirty (30) pillars.

FIG. 3B illustrates five different pillar configurations whereby the position of the net circulation is controlled by pillar location. Above each pillar configuration is shown the respective net deformation arrow plots as predicted by numerical simulations. Below are confocal cross-sectional images of the microfluidic channel at different downstream locations for each pillar configuration.

FIG. 4A illustrates a comparison of Stokes and inertial flow development along the channel near the pillar (shown in the top-right quarter of the channel).

FIG. 4B is a graph of σ—the maximum fluid transfer normalized by the downstream flow velocity—as a function of Reynolds number (Re).

FIG. 4C illustrate simulation results of a vertical set of inlet streamlines and their deformations in a quarter of the channel at four different Reynolds numbers. The top-view of streamlines at z=0 reveals the creation of post-pillar eddies with increasing Re which corresponds to the shift from increasing to decreasing σ with Re. The front view illustrates the outline of an initially vertical line of fluid parcels at the inlet (labeled dashed line, x/D=−4), traced at x=0 (labeled dashed line, x/D=4) and the outlet (labeled solid line). Solid lines show channel walls and the dash-dot lines indicate channel symmetry. The grey area shows the outline of a quarter of the pillar in the respective channel quarter.

FIG. 4D illustrates a phase diagram for inertial flow deformation for a simplified case when the deformation-inducing obstacle is a cylindrical pillar at the center of a straight channel showing four dominant modes of operation. Non-dimensional analysis proves that a set of three independent non-dimensional groups are needed to define a specific condition (shown on the axes). The phase diagram shows which mode is in effect at any given set of non-dimensional groups, or equivalently a given set of flow conditions and geometric parameters.

FIG. 4E illustrates confocal cross-sectional images taken of the four modes that were achieved experimentally. The images, showing the flow pattern in a quarter of the channel, are overlaid with arrows indicating the direction of motion for that mode of operation.

FIG. 5A illustrates a top view of the lateral position of pillar centers at various positions within a microfluidic channel.

FIG. 5B illustrates four different programs (i.e., sequence of pillars and the inlet condition of the stream of interest) based on selected pillar positions using the scheme of FIG. 5A. Illustrated below each program is the respective cross-sectional flows based on the numerical prediction of flow as well as experimental observations. Note that numerical predictions are not based on full finite element simulations of the flow around the sequence of pillars but the sequential mapping of the basic operators from the library.

FIG. 5C illustrates eight different programs as well as the respective cross-sectional flows showing the variety of geometric shapes that can be produced by different programs.

FIG. 5D illustrates inlet and outlet images, respectively, of a microfluidic channel whereby particles contained within a carrier fluid are separated from the carrier fluid after passing a sequence of obstacles. The last obstacle in the sequence can be seen in the “outlet” image.

FIG. 5E illustrates 10 μm sized particles that remain focused near the centerline while 1 μm sized particles follow laterally displaced fluid streams, resulting in the separation of the two populations.

FIG. 6A illustrates a microfluidic channel that is used to exchange fluid around particles according to one embodiment.

FIG. 6B illustrates a cross sectional view of showing the particles and fluid being inertially focused within the microfluidic channel, before reaching the pillars.

FIG. 6C illustrates a cross sectional view of showing the particles and fluid after being passed through a first program.

FIG. 6D illustrates a cross sectional view of showing the particles and fluid after being passed through a second program.

FIG. 6E illustrates a view of the outlets coupled to the microfluidic device of FIG. 6A.

FIG. 7 illustrates fluorescent images taken of the inlet and outlet of a microfluidic channel that uses sheath flow in combination with a program to cause a single, fluorescently labeled stream to split into three (3) streams at the outlet.

FIG. 8 illustrates cross-sectional confocal views of microfluidic mixing of a stream.

FIG. 9A illustrate a microfluidic channel based device that uses sheath flow in conjunction with programmed fluid flow to manufacture a polymerized fiber having custom made cross-sectional shape.

FIG. 9B illustrates the cross-sectional view of the polymer precursor aligned within the sheath fluid.

FIG. 9C illustrates the cross-sectional shape of the polymer precursor after passing through the programmed area of the microfluidic channel.

FIG. 9D illustrates a fiber created from the polymer precursor, after being shaped into the desired shape and undergoing polymerization.

FIG. 10A illustrate a microfluidic channel based device that uses sheath flow in conjunction with programmed fluid flow to manufacture three dimensional particles.

FIG. 10B illustrates the cross-sectional view of precursor material aligned within the sheath fluid.

FIG. 10C illustrates three different types of programmed fluid geometries that can be created by passing the fluid by one or more operators as part of one or more program(s).

FIG. 10D illustrates the formation of an individual particle by exposure of light through a mask onto the shaped flow within the microfluidic channel.

FIG. 10E illustrates outlets of the microfluidic channel device of FIG. 10A.

FIG. 11A illustrates a microfluidic channel that is used to create focused fluid stream for subsequent optical interrogation such as flow cytometry, or for reducing dispersion of the fluid stream.

FIG. 11B illustrates the initially established sheath flow cross section.

FIG. 11C illustrates a cross-sectional view of the focused stream after being subject to the program.

FIG. 12 illustrates a microfluidic device that uses flow splitting to generate two cold streams adjacent to two hot spots or regions.

FIG. 13A illustrates a cross-sectional view of a microfluidic channel having binding entities on an upper and lower surface with target species located in about one half of the channel volume.

FIG. 13B illustrates a cross-sectional view of a microfluidic channel having binding entities on an upper and lower surface with target species being focused adjacent to the upper and lower surfaces.

FIG. 13C illustrates a cross-sectional view of a microfluidic channel having binding entities on an upper and lower surface with non-specific binding molecules being focused away from the upper and lower surfaces.

FIG. 14 illustrates a cross sectional image (top) of a plug of fluid having a uniform gradient. FIG. 14 further illustrates two different programs (A and B) that create, respectively, different gradients of the plug of fluid within the microfluidic channel.

### DETAILED DESCRIPTION OF THE ILLUSTRATED EMBODIMENTS

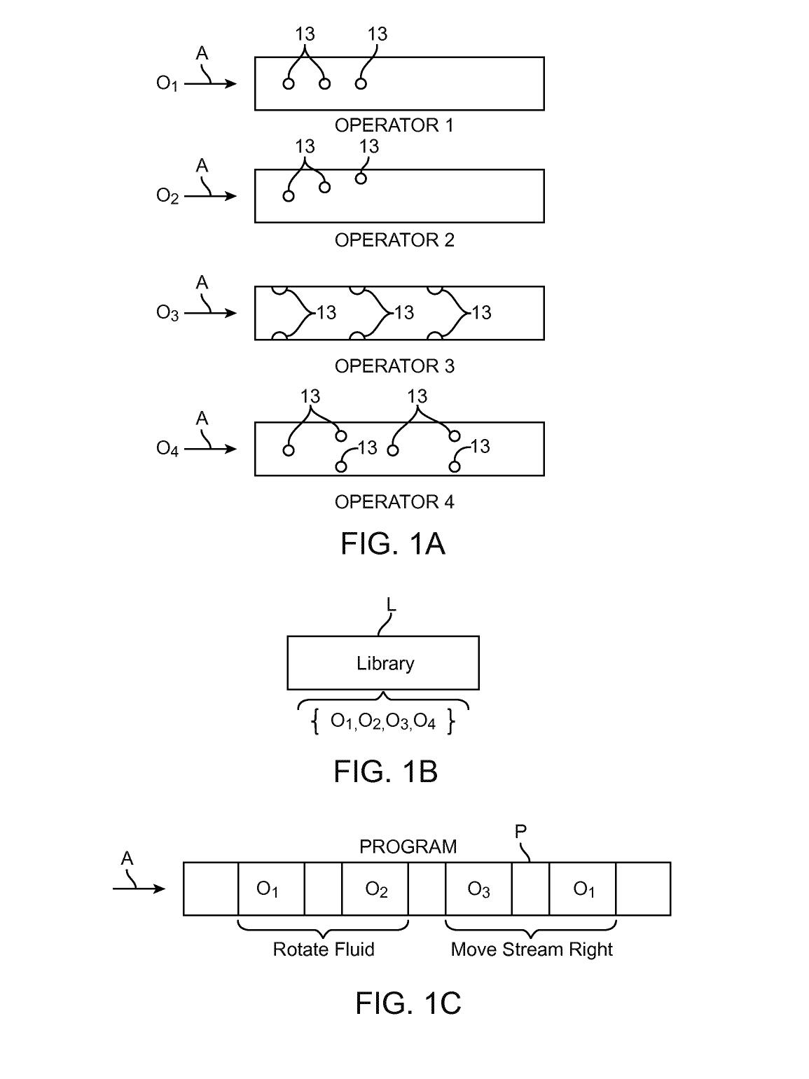

FIG. 1 illustrates a schematic representation that generally represents a method and technique to selectively shape the cross-section of a fluid stream 10 flowing within a channel such as a microfluidic channel 12. The method includes three main components: (1) operators (O₁, O₂, O₃) which are a set of approaches to transform the lateral location of fluid parcels locally within the microfluidic channel 12; (2) a library which is a set of transformations on the flow that each discrete operator performs; and (3) programs which is a sequence of operators that codes for more complex shapes by sequentially applying the transformations to fluid. The sequence of operators is physically manifested in a sequence of flow-deforming elements that are far enough apart that each can be assumed to act independently on the flow.

FIG. 1A illustrates four such illustrative operators (O₁, O₂, O₃, O₄) that create a local net secondary flow oriented generally perpendicular to the direction of flow indicated by arrow A. Operators can include a variety of approaches that achieve a lateral motion of fluid locally within a microfluidic channel 12. Operators may include structured channels in which diagonally slanted grooves create a helical motion in regions of the flow near the grooves such as that disclosed in Stroock et al. See Stroock et al., Chaotic Mixer for Microchannels, Science 25 Jan. 2002: Vol. 295 no. 5555 pp. 647-651, which is incorporated by reference. Operators may also include one or multiple posts 13 (or pillars) as illustrated in FIG. 1A or obstructions of cylindrical, square, rectangular, triangular, polygonal, oval, half-circle, or other cross-sectional shape and various diameters that span the entire microfluidic channel 12 cross-section. The cross-sectional shape of individual operators may be uniform along their length, or, alternatively, the cross-sectional shape may vary. Operators may also include partial posts 13 that do not span the entire cross-section of the microfluidic channel 12 but somewhere between about 10% to about 90% of the cross-section also of varying diameters. Operators may also include one or more steps. Operators may also include generally any protuberance or irregularity disposed within a microfluidic channel 12 that creates a local secondary flow (i.e., flow perpendicular to the main fluid motion). These physical operators are known to manipulate fluid flow over the whole laminar flow range (the only regime where deterministic flow manipulation is fundamentally possible). The fluid programming techniques described herein can be used over a wide range of flow rates (e.g., Re˜1-500) for protuberances that have mirror symmetry in the flow direction, and Re down to 0—Stokes flow—for structures that are asymmetric in the flow direction like grooves.

As seen in FIG. 1A, four different operators are illustrated, each operator (O₁, O₂, O₃, O₄) having multiple posts arranged in different lateral configurations within the microfluidic channel 12. These operators are, however, illustrative of one type of operator that can be used in connection with the platform and methods described herein. As one embodiment of an operator, as illustrated herein, relatively simple obstacles (e.g., cylindrical pillars) disposed in a microfluidic channel 12 at different locations within the channel cross-section, at moderate to high flow rates, tend to turn and stretch streamlines in a manner that, unlike intuition for Stokes flow, does not precisely reverse after passing the pillar. The asymmetric flow behavior upstream and downstream of the pillar due to fluid inertia manifests itself as a total deformation of the topology of streamlines that effectively creates a tunable net secondary (perpendicular) flow which resembles the recirculating Dean flow in curving channels. Importantly, the secondary transport remains relatively constant for each downstream distance over an order of magnitude of Reynolds numbers (or flow rates) enabling easy prediction of the programmed flow field based on one mapping of transport after passing a pillar, without having to simulate each new configuration. As another embodiment, structures like herringbones (an array of spaced angled grooves in the channel sidewall) can be used to program fluid flow at low to moderate flow rates.

Referring now to FIG. 1B, a library L of operators consists of a discrete number of transformation maps that correspond to each operator. Each transformation map consists of a 2D matrix of vectors that give the displacement of fluid parcels at each position within a channel cross section with high resolution upon interacting with the operator (e.g., flowing past a cylindrical obstacle). Transformation maps can be obtained by fluid dynamic numerical simulation of the incompressible Navier-Stokes equations and tracing of streamlines (which are the same as pathlines, considering the steady-state nature of the flow) to find the lateral motion of fluid parcels in the cross section of the microfluidic channel 12. For example, fluid dynamic simulation of fluid flow around a post or pillar is used in one embodiment. The library of operators may contain between as little as four (4) to as many as tens of thousands of operators by combining different pillar shapes, sizes and positions, as well as channel sizes and flow conditions in the most general case. As seen in more detail below, one library embodiment contains eight (8) discrete operators that correspond to eight (8) positions of cylindrical pillars within the microfluidic channel 12 cross-section for one flow condition. In general, the library L would be considered complete if it contains sufficient operators to effect fluid motion over the entire cross section of the microfluidic channel 12. That is, there should be operators that are spatially located across the channel with overlapping domains of fluid manipulation, such that sequencing of multiple operators in programs allows for continuous deformations of the fluid stream and creation of arbitrary cross-sectional shapes across the entire cross-section of the channel.

As seen in FIG. 1C, Programs P may be developed from sequences of operators from a library L. A program will apply a series of transformation maps proscribed by the user in a given order yielding an overall deformation of the fluid. For example, in the Program P of FIG. 1C, the serial combination of operators O₁ and O₂ are used to rotate the fluid while the next operators O₃ and O₁ are used to move fluid to the right. Such smaller subsets of operators in sequence that perform more complex deformations as “functions” can be developed and hierarchically assembled. Physically, the programs may manifest as a channel with a series of cylindrical obstacles centered at different lateral positions in the channel. Care must be taken, such that the distance between operators (e.g., obstacles) is such that they act independently fluid dynamically (i.e., their effects do not spatially overlap in the flow direction). This optimal distance depends on the flow conditions but is often between about 4-15 post diameters apart. Note that flows can be split into multiple microfluidic channels 12 (separated by walls) or the flow can be expanded by widening the channel and separate programs run on part of the fluid stream in the channel(s) in parallel as well. The microfluidic channels 12 can then be recombined if needed to perform more complex manipulations. Programs can be designed from a library with little to no knowledge of fluid dynamics by the user.

Overall, this method creates the possibility of exceptional control of the three-dimensional (3D) structure of the fluid within a microfluidic channels 12, which can significantly advance various applications where there is a need for fluid interface control or manipulation, from medical diagnostics and health surveillance to chemistry, thermal management, and materials science.

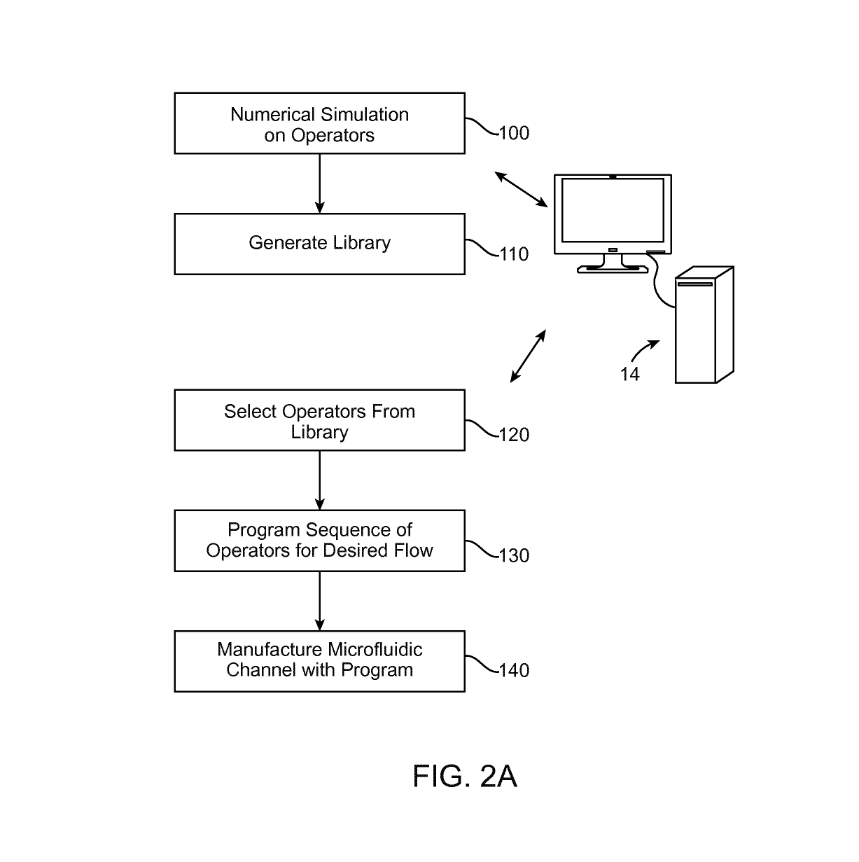

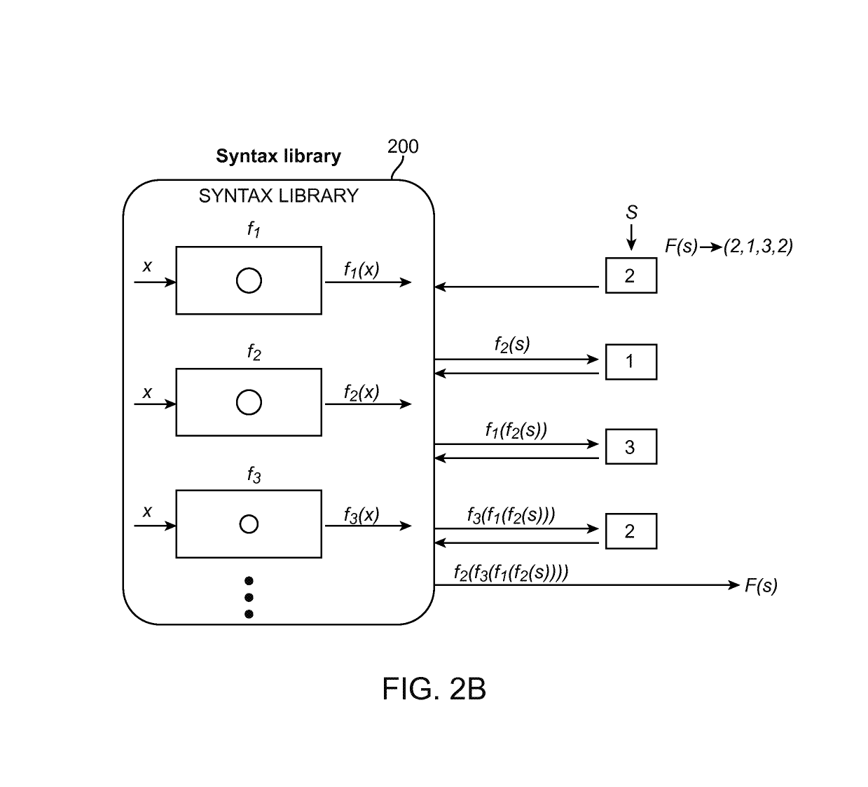

With reference to FIG. 2A, a computer 14 can be used to numerically predict flow deformation as a result of fluid flowing past a single operator or multiple operators in series (e.g., posts or pillars). Simulations can be performed based on stabilized finite element (FEM) methods. Upon simulation, the output of each operator in series can be taken as the input for the following or subsequent operator in a simple numerical mapping program provided such operators are appropriately spaced within the microfluidic channel 12 without additional time-intensive and complex FEM simulation. As seen in FIG. 2A, a computer 14 can be used to numerically simulate the operators 100. This numerical simulation 100 can then be used to generate a library 110 of operators that can produce various desired flow movements or states. The library 110 may be contained within a database or the like that is contained within or accessible by the computer 14. For example, software may be run on the computer 14 wherein a user can build a custom fluid flow program from a library of operators. These may be contained within the software in a user-friendly format that associates a particular flow feature associated with one or more operators. For example, the user can select from the library a single operator or a function consisting of a series of operators that is used to “move the fluid stream to the right.” The user does not need to know any fluid mechanics and there is no need to re-model the fluid effect as this work has already been done in establishing the library. In order to create a desired or programmed flow within a microfluidic channel 12, one or more operators are selected from the library as seen in operation 120 of FIG. 2A. It is important to note that once the library of operators has been generated and stored (e.g., within the computer 14 or elsewhere) a user can then use this library of pre-simulated motions to build or engineer a flow shape. The user does not need to have any knowledge about fluid mechanics or numerical simulations created by the operator as these have already been created and compiled as part of a library that is then available as a tool set to create the desired fluid flow. A program is then created as seen in operation 130 where a sequence of operators is established that will produce the desired fluid output based on an initial condition of the microfluidic channel 12. The inlet condition of the microfluidic channel 12 in the width of the fluid stream and the inlet position of the stream to be modified. A device having a microfluidic channel 12 with the programmed features can then be manufactured as seen in operation 140.

By having the transformation function for a limited set of operators (e.g., pillar size, shape, lateral position, channel size), the computer 14 can predict the total transformation function of any potential program, of which there is an infinite number. Consequently, a user can use the library of pre-simulated motions and place these in series to engineer a flow shape of interest quickly, at a low cost, and with high accuracy without any knowledge of fluid mechanics or numerical simulations. Systematic discretization of the operators, similar to discretization of musical notes, allows abstraction and hierarchical assembly of programs, increasing the ability to engineer complex fluid systems. Therefore, each program is simply communicated using the inlet condition of the microfluidic channel 12 and the sequence of operators developed per the program.

FIG. 2B illustrates schematically how a series of individual operators can be combined to produce a desired output flow. FIG. 2B illustrates a syntax library 200 that includes a plurality of different individual operator map (f₁,f₂,f₃). Each operator map may include one or more different configurations of posts, pillars, or other protuberances which produces a different flow deformation result. FIG. 2B illustrates this, for instance, as different positions of a post (or other protuberance) within a channel for each operator map (f₁,f₂,f₃) although it should be understood that multiple posts (or protuberances) may define a function that also can be stored in a library. Moreover, while only three operator maps are illustrated, there can be any number of operator maps contained within the syntax library 200. In the example illustrated in FIG. 2B, a final fluid deformation map F(s) is created based on an initial condition S. The initial condition S generally refers to any configuration of fluid parcels at the inlet of the program. More specifically, it could correspond to properties of the number of discrete streams that will be input through the device. This may include, for example, the number of discrete streams and their respective widths and positions which are also sets of inlet fluid parcels (e.g., three streams with the middle stream containing particles and having a width of 15 μm). In the illustrated embodiment, the final fluid deformation map F(s) is assembled by combining, in serial fashion, three separate operator maps (f₁,f₂,f₃) in four logic steps starting first with the second operator map (f₂), followed by the first operator map (f₁), followed by the third operator map (f₃), finally followed by the second operator map (f₂). Thus, the final fluid deformation map F(s) is equal to f₂(f₃(f₁(f₂(s)))).

Experimental

To investigate the ability of programming fluid flow using a sequence of microstructures, cylinders were placed at various cross-stream locations of a microfluidic channel and thus acted as the operators in the programming scheme. These geometric obstacles can be used to induce significant deformations in flow, creating useful net rotational secondary flows that locally move fluid parcels and deform fluid streams. Notably, this net twisting of fluid around a pillar has been neglected in prior microfluidic systems because fluid inertia is often not considered important. Flow around a pillar in a straight channel without inertia (i.e. Stokes flow) requires fore-aft symmetry because of the mirror symmetry of the flow upon time-reversal of the linear equations of motion. Therefore, any secondary fluid motion directed within the channel cross-section is completely reversed after passing the cylinder midplane.

Unlike the fluid motion that completely reverses upon passing a micropillar for Stokes flow, flow with finite inertia is accompanied by a net deformation of fluid streams. Numerical simulations predict that as fluid passes centrally positioned pillars in a straight microchannel, the flow deforms in such a way that the fluid parcels near the channel centerline move outwards towards the side walls, while fluid parcels near the top and bottom walls move towards the channel center. This phenomenon, validated experimentally, effectively creates a set of net rotational secondary flows within the microfluidic channel. As a result, the flow is irreversibly twisted, losing its fore-aft symmetry near the pillar and causing a significant final deformation of the flow stream. The phenomenon has features in common with the secondary flow created in curved channels with finite inertia (Dean flow). Both phenomena are inertially induced and require high velocity gradients provided by confined 3D channels, such that regions of the curving flow have differing levels of momentum.

Microfluidic devices were fabricated using polydimethylsiloxane (PDMS) replica molding processes, although fabrication in glass, thermosetting, or thermoplastic materials as known to one skilled in the art can also be performed. Standard lithographic techniques were used to produce a mold from a silicon master spin-coated with SU-8 photoresist (MicroChem Corp.). PDMS chips were produced from this mold using Sylgard 184 Elastomer Kit (Dow Corning Corporation). Inlet and outlet holes were punched through PDMS using a pin vise (Technical Innovations, Inc.). PDMS and glass were activated by air plasma (Plasma Cleaner, Harrick Plasma) and bonded together to enclose the channels. In order to see the PDMS walls of the channel Rhodamine B red dye, which permeates PDMS, was infused into the channel and washed prior to the experiments. For primary experiments using posts or pillars, the microfluidic channel dimensions were 200 μm (width)×50 μm (height) with posts of 100 μm in diameter spaced apart from adjacent posts by 1 mm. Although fabrication of microscale channels and protuberances is presented, the fluid deformation and programming phenomenon is scalable to various length scales and fabrication processes as long as Reynolds numbers, and other dimensionless parameters are kept within the described ranges. For symmetric protuberances, flow should be in the laminar flow regime (e.g., 1<Re<2000). To get significant deformation magnitudes for pillars, normalized pillar diameters (pillar diameter divided by channel width) should be above around 0.05. Smaller Re can be used for asymmetric protuberances like grooves.

To help visualization, the fluid stream was mixed with FITC Dextran 500 kDa (4 μM in deionized water) or with blue food dye. Fluorescent monodisperse particles (1 μm and 10 μm, 1.05 g/ml) were purchased from Duke Scientific. Particles were mixed in deionized water. Fluid streams and particle suspensions were pumped into the devices through PEEK tubing (Upchurch Scientific Product No. 1569) using a syringe pump (Harvard Apparatus PHD 2000). The device works efficiently over a wide range flow rates and works particularly well within the range of 100 microliters/minute and 500 microliters/minute (Re within range of around 6 to 60).

Confocal imaging was performed using a Leica inverted SP1 confocal microscope. Confocal images are the average of 8 y-z scans. Fluorescent images were recorded using a Photometrics CoolSNAP HQ2 CCD camera mounted on a Nikon Eclipse Ti microscope. Images were captured with Nikon NIS-Elements AR 3.0 software. For high-precision observations and measurements, high-speed images were also recorded using a Phantom v7.3 high-speed camera (Vision Research Inc.) and Phantom Camera Control software.

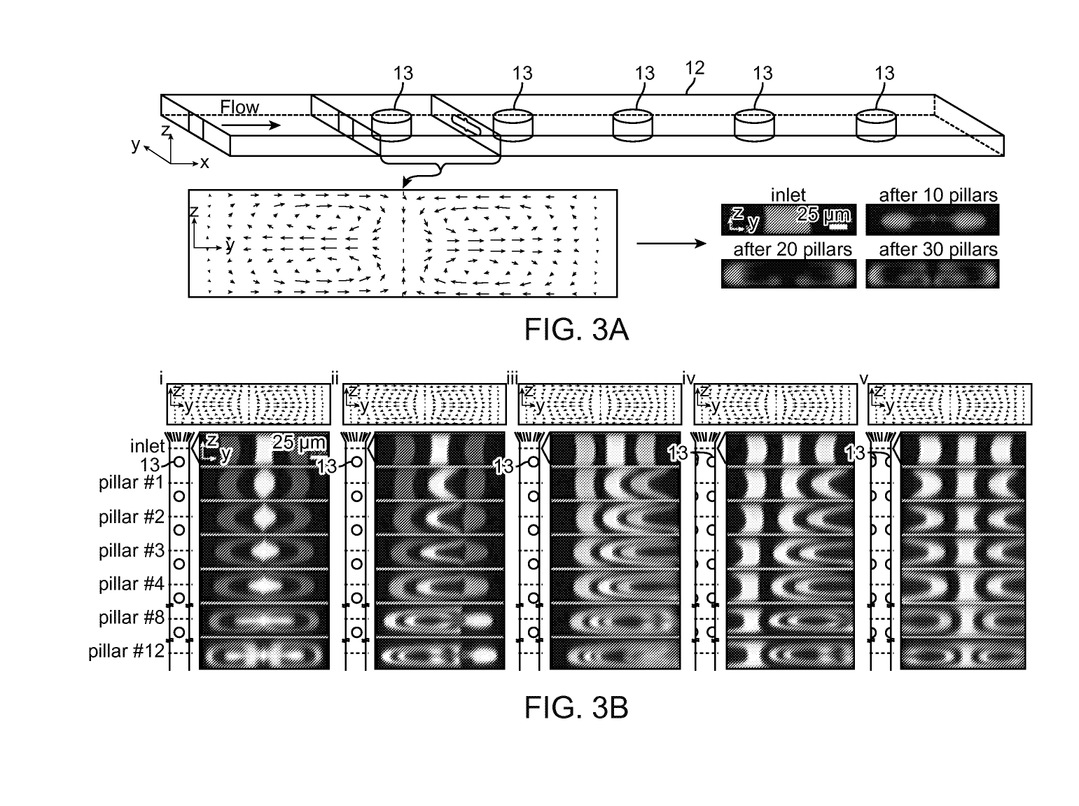

FIG. 3A schematically illustrates local inertial flow deformation induced by pillar microstructures 13. The arrow plot of FIG. 3A illustrates average lateral velocity filed as fluid parcels travel from the input cross-section (upstream) to an output cross-section (downstream). FIG. 3A also illustrates a cross-sectional image of fluid flowing through the microfluidic channel at the inlet, after ten (10) pillars 13, after twenty (20) pillars 13, and after thirty (30) pillars 13.

FIG. 3B illustrates five different pillar configurations whereby the position of the net circulation is controlled by pillar location. Above each pillar configuration is shown the respective net deformation arrow plots as predicted by numerical simulations. Below are confocal cross-sectional images of the microfluidic channel at different downstream locations for each pillar configuration. The respective lateral placement of the pillar sequences is seen adjacent to each panel of images. Three fluorescently labeled streams are traced for observations. As seen in FIG. 3B, by displacing the pillar center from the middle to the side of the channel (from configuration i to configuration v), the lateral position of the net recirculating flow is similarly displaced.

In contrast with Dean flow, however, the lateral position of the pillar can be used to tune where the net recirculating flows are created across the channel as seen by FIG. 3B. By moving the sequence of pillars across the channel (in the y-direction) the center of motion follows. This positioning enables spatial control over the induced deformation, for instance by replacing the central pillars (FIG. 3B image i) with pairs of side half-pillars (FIG. 3B image v) the direction of the net secondary flows is reversed.

The majority of the induced deformation occurs within four pillar diameters of the pillar for the flow conditions used, proscribing an effective spacing between pillars for which the transformation from each individual pillar of a sequence behaves independently. Numerical comparison of Stokes and inertial flow development along the channel near the pillar indicates that the presence of the pillars leads to deformation of streamlines and while this deformation possesses fore-aft symmetry in Stokes flow, in agreement with the mirror-symmetry time-reversal theorem, the symmetry is broken in the presence of inertia.

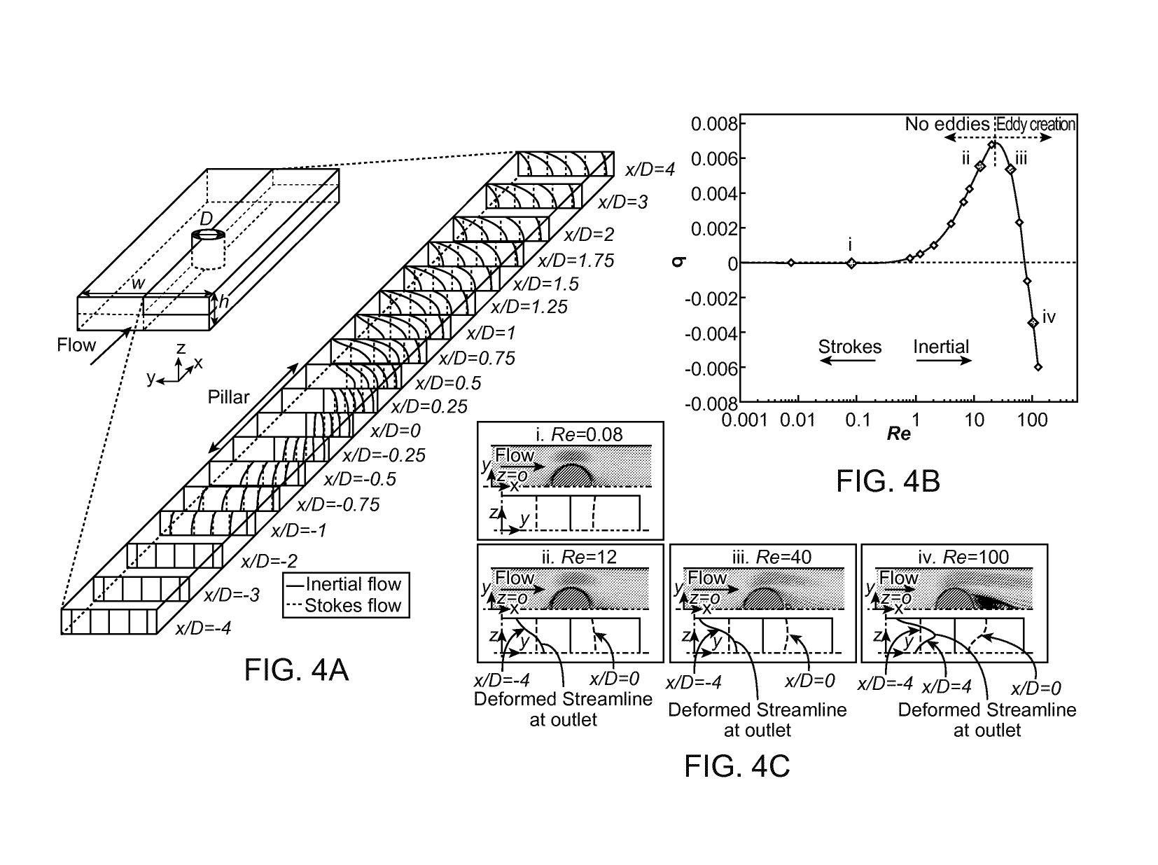

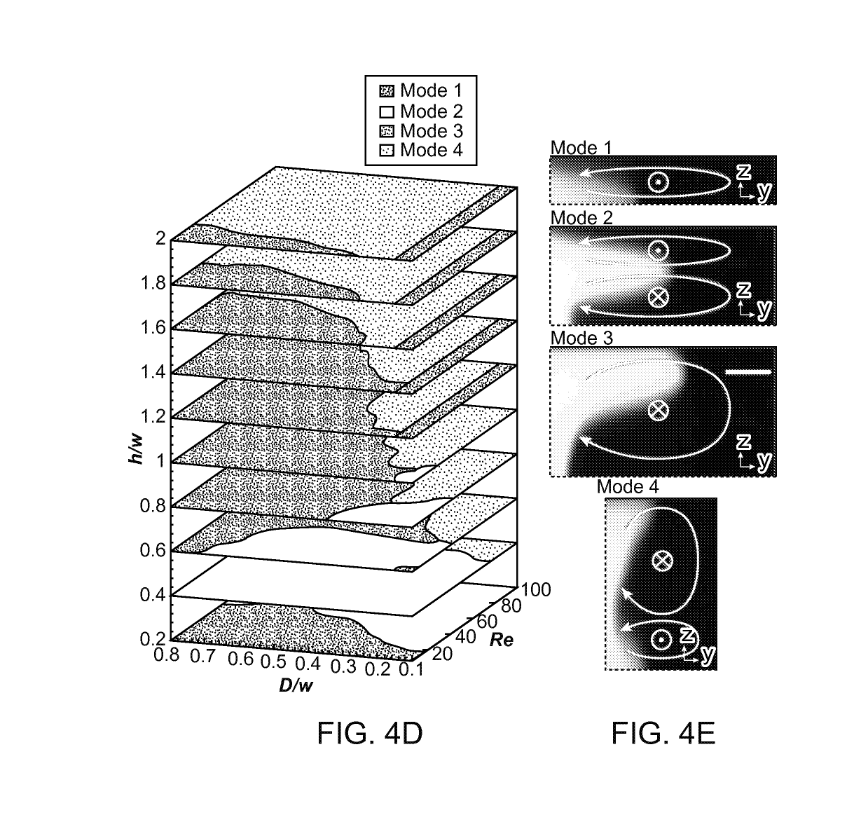

This can be observed in FIG. 4A which illustrated the development of the inertial flow deformation and operating regime. FIG. 4A illustrates a comparison of Stokes and inertial flow development along the channel near the pillar (shown in the top-right quarter of the channel). In each cross-section, using numerical simulations, five vertical lines of tracer fluid parcels are followed as they move past the obstacle and reach a stable state. The fore-aft symmetry of deformation that exists in Stokes flow is broken in the presence of inertia.

Upstream, the inertial flow does not diverge greatly compared to Stokes flow. The two flows nearly match at x=0 (i.e., the position of the pillar center), while downstream of the pillar the inertial flow diverges greatly from Stokes flow creating a large deformation compared to the initial fluid topology. This turning motion saturates approximately 3-4 pillar diameters downstream, such that in the experiments an inter-pillar spacing of ten pillar diameters was set to ensure that when placed in a sequence the downstream flow profile of a previous pillar did not interact with the upstream profile of the next pillar. In this way the transformations performed by each pillar could be sequentially applied, without cross-talk between the independent operations which would require fluid dynamic simulation of the combined sequence.

The relatively uniform behavior of inertial flow deformation over a range of flow rates in finite-Reynolds number laminar flows is an important feature for programming. The Reynolds number is a ratio of inertial to viscous forces in the flow:

Re=ρUH/μ

wherein, H is the hydraulic diameter or characteristic size of the channel, U is the mean downstream velocity of a fluid with density ρ and viscosity μ). The magnitude of the flow deformation away from the middle of the channel at z=0 was measured, by defining σ, a normalized value that can be used to quantitatively compare the amount of lateral fluid motion for different flow and geometric conditions. It is defined as the mean of the net lateral velocities at z=0 (middle height of channel), normalized by the average downstream velocity of the main flow, or:

σ≡((V_{y})ₘₑₐₙ)z₌₀/(Vₓ)_{avg}

This is essentially a measure of the distance fluid has moved laterally (on average and at the channel mid-plane) per unit of length it travels downstream. σ remains uniform over an order of magnitude of conditions (for Re˜6-60) as seen in FIG. 4B, varying only by a factor of 2-3. Furthermore, while the net secondary flows behave consistently over a wide range of flow rates with a single pillar diameter, σ was found to be tunable by adjusting the pillar diameter. A closer examination of flow as a function of Re (FIG. 4C) reveals that for small channel Reynolds numbers, the flow behaves similar to Stokes flow, with no discernible flow deformation (image i. of FIG. 4C Re=0.08). Other methods to deform flow using structured channels may be complementary for these conditions, however these approaches operate less effectively as Re increases. In contrast, for the cylinders used here, as Re increases significant inertial flow deformation is observed (image ii. of FIG. 4C Re=12). Increasing Re further leads to boundary layer separation along the downstream surface of the pillar and creation of post-pillar wake regions (image iii. of FIG. 4C Re=40) in which the inertial flow deformation starts to manifest more complex behavior (image iv. of FIG. 4D Re=100). In this case, it was observed that the fluid parcels near the top of the channel move towards the channel center and that the flow starts to deform away from the channel center further towards the z-midplane. Unexpectedly, the deformation is again directed towards the center at z=0 (image iv. of FIG. 4C). These results identify a range of flow conditions required to operate in a single mode but also suggest the ability to make use of separate modes of operation with more complex fundamental transformations over different flow conditions. For example, the different modes can be predicted in advance and included in the library to aid in programming fluid flow over different flow regimes.

Following the identification of this unexpected complexity in the single pillar system, we systematically classified the range of possible flow deformations over the set of practically achievable controlling geometric and flow parameters. Dimensional analysis predicts that the behavior of the system is described using three non-dimensional groups (when assuming two constraints: (1) pillars are cylindrical and (2) they are located at the center of the channel): Re, channel aspect ratio h/w, and normalized pillar diameter D/w as seen in FIG. 4D which illustrates a phase diagram showing the modes in effect at any given set of flow conditions and geometric parameters. For the case when the flow deformation-inducing obstacle is a cylinder at the center of a straight channel, four dominant modes of operation were uncovered for inertial flow deformation. Similar modes of operation are expected for non-cylindrical pillars and those not located at the channel centerline. FIG. 4E illustrates confocal cross-section images of the asymmetric quadrant of flow overlaid with arrows indicating direction of motion for the respective mode of operation. The modes are defined based on the number of induced net secondary flows in a quarter of the channel (i.e., one or two), as well as the direction of the net vorticity axis for each of these flows (FIG. 4E). Based on the numerical simulations it is predicted that four additional transitional modes of operation also exist, especially when pillar diameter is small. However, these modes exist over very narrow regions in the phase diagram. Furthermore, for small D/w the net rotational flow remains weak, such that these modes are not practically useful.

Inertial flow deformation depends on gradients in fluid momentum and pressure across the channel cross-section that do not identically reverse fore and aft of the pillar. When there are no eddies present behind a pillar the flow deformation occurring in this region dominates over the opposite-directed deformation occurring upstream of the pillar (FIG. 4A). Regions of lower pressure were observed in the middle of the channel (due to the higher velocity fluid in this region), between two regions of high pressure on the top and bottom of the channel (near y=0). This leads to center-directed motion of fluid parcels from the top and bottom of the channel, which is accompanied by movement of fluid parcels in the middle region to the sides, conserving mass (mode 1). However, increasing Re or changes in system geometry (e.g., increasing channel aspect ratio) leads to creation of post-pillar eddies, which form a three-dimensionally complex closed region of recirculation behind the pillar. This wake causes a reduction in the curvature for fluid streams transiting behind the cylinder and accompanying changes in the pressure field. The combination of these effects reduces the dominance of the deformation occurring downstream of the pillar, shifting the balance to the upstream deformation with net fluid rotation in the opposite direction, which corresponds to alternate modes of operation.

The flow deformation operations can be integrated to execute sophisticated programs and render complex flow shapes. As explained herein, one can numerically predict the inertial flow deformation near a single pillar with high precision as seen by FIG. 3B. By placing a set of operators (e.g., a set of pillars) that are appropriately spaced and sequentially placed along a microfluidic channel, the output of each pillar can be taken as the input for the following pillar and the net deformation produced by the pillars can be sequentially combined. Therefore, by having the transformation function for a limited set of pillar configurations (i.e., pillar size, lateral position), one can predict the total transformation function of any potential program, of which there is an infinite number.

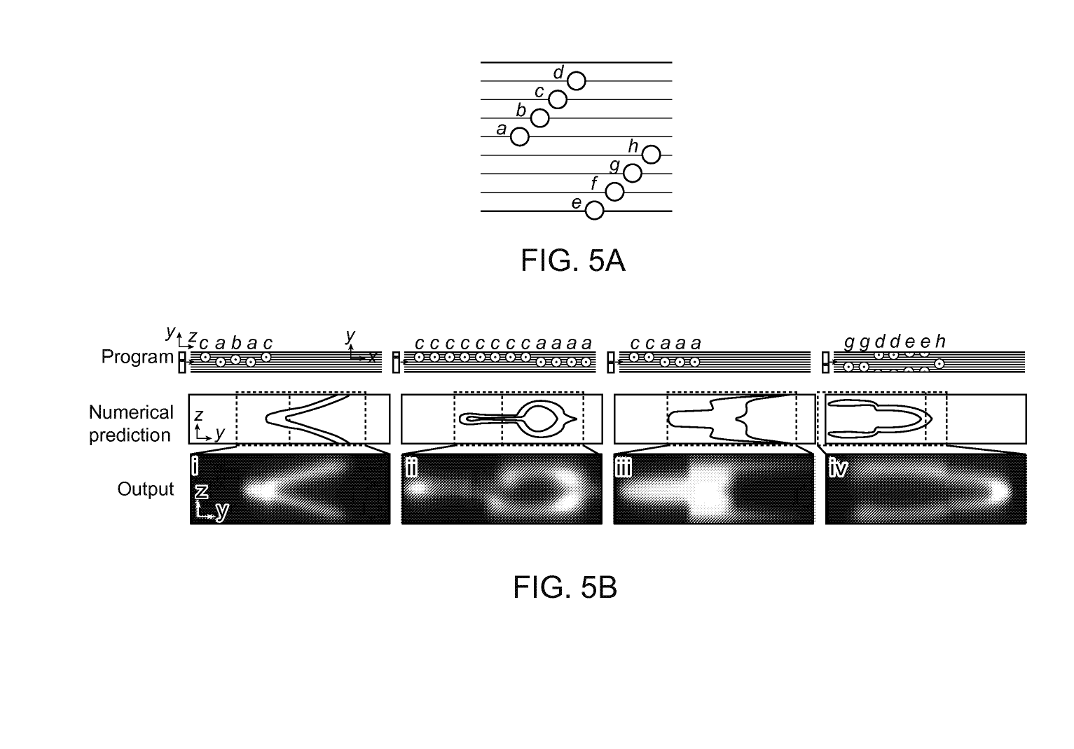

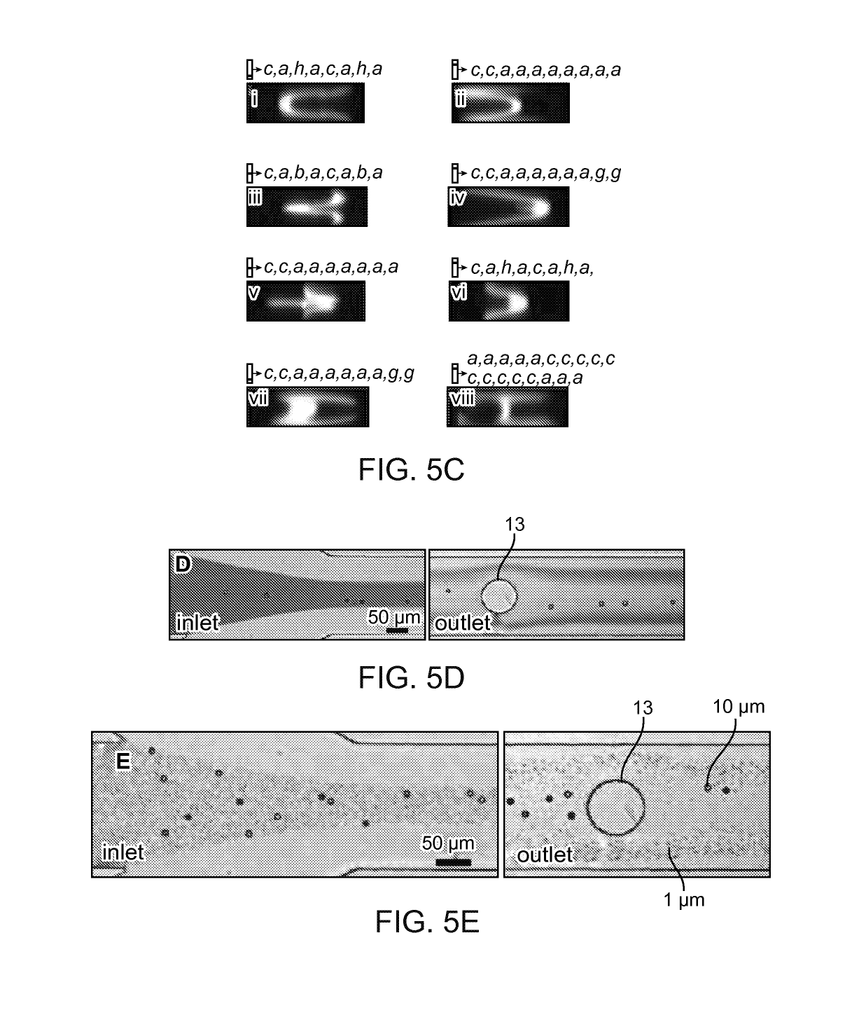

Consequently, as described with respect to FIG. 2A, a user can use a library of pre-simulated motions and place these in series to engineer a flow shape of interest quickly, at a low cost, and with high accuracy without any knowledge of fluid mechanics or numerical simulations. Systematic discretization of the pillar positions, similar to discretization of musical notes, allows abstraction and hierarchical assembly of programs, increasing the ability to engineer complex fluid systems. For example, FIG. 5A illustrates discrete positions of pillars in positions a, b, c, d, e, f, g, and h of a microfluidic channel.

FIG. 5B illustrates a series of four (4) different programs using a sequence of differently placed pillars within a microfluidic channel. Each program consists of (1) a sequence of pillars positioned at different locations across the channel, and (2) an initial condition, i.e., inlet position and width of the fluid stream. Below each program are illustrated the numerical predictions based on sequencing operations obtained from a library of single-pillar flow transformation maps. Also included below each respective numerical prediction are confocal cross-sectional fluorescent images of the observed flow. As seen by the comparison of the actual confocal images and the numerical predictions, the computed transformation maps match very close to the experimental results.

FIG. 5B in the first program illustrates an initially straight stream that is transformed into a V-shape using a program of (c a b a c). The variety of attainable shapes include closed loops as seen in the second program of FIG. 5B (c c c c c c c c a a a a). Sharp bends can be created as seen in the first, third, and fourth programs of FIG. 5B. FIG. 5C illustrates another series of programs based on the pillar positions seen in FIG. 5A. As seen in FIG. 5C, biconcave and biconvex areas are formed (images vii). In other programs (e.g., images i, iii, vi) there are added vertices compared to the initial stream and multiple changes in curvature. As a result, analogous to software programming, a user can build upon previously demonstrated functions and integrate them in new ways to create more complex and useful flows.

There are many different applications where the platform and method may be used. For example, the platform can be used to control particle streams such as, for instance, particles in the form of functionalized beads or biological particles such as cells, bacteria or toxins. Solution exchange around particles is especially useful for sample preparation, to remove the surrounding liquid or to bring a given reactant into the particle suspension. Additionally, selective separation of particles can be conducted due to the secondary flow interacting with underlying inertial lift forces acting on those particles and can enable size-based segregation of particles. FIG. 5D illustrates the extraction of particles from a fluid stream. As seen in FIG. 5D, the darkened carrier fluid is located away from the centerline while the particles remain generally aligned along the centerline. The fluid thus moves away from the channel leaving the particles maintained at the centerline due to inertial focusing. Using a similar process, different sized particles can be separated by using this platform. For example, depending on whether inertial lift or drag from secondary flow dominates, different sized particles have different equilibrium positions thereby enabling separation. As seen in FIG. 5E, 10 μm sized particles remain inertially focused while 1 μm sized particles follow fluid streams. Particles include living or bioparticles such as cells, bacteria, protozoa, viruses, and the like and may also include non-living particles such as beads (e.g., glass, polystyrene, PMMA, etc.) which may optionally be functionalized or conjugated with other reagents.

The platform may also be used to switch or exchange fluid around particles. For example, the platform may bring a particular fluid stream into contact with particles. This may include a lysis buffer or staining solution for example. Solution exchange may be used to remove the buffer or other carrier fluid initially around particles (e.g., washing of DMSO around cells, washing of dyes, removing platelets or toxins.). FIG. 5D illustrates particles that are initially contained in one fluid (darkened) at the inlet that are then exchanged with another fluid near the outlet. The initial, darkened fluid is moved laterally away from the centerline.

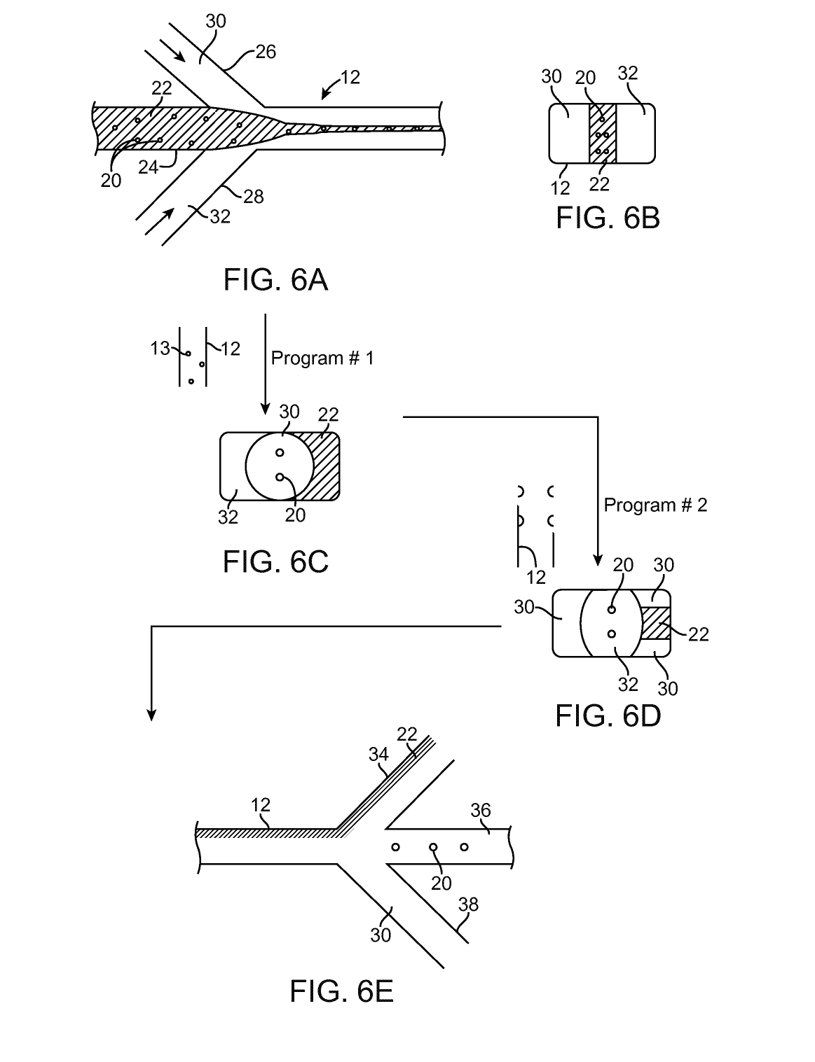

FIG. 6A illustrates a microfluidic channel 12 that is used to exchange fluid around particles 20. A fluid 22 containing the particles 20 is input into a first input 24 of the microfluidic channel 12. Sheath flow is established through two additional inputs 26, 28. One input 26 is used to deliver a reaction buffer 30 while the other input is used to deliver a wash buffer 32. The reaction buffer 30 and the wash buffer 32 pinch the fluid 22 containing the particles 20 into a sheath flow. A cross sectional view of a channel showing the particles 20 and fluid 20 being inertially focused within the microfluidic channel 12 is seen in FIG. 6B. A program of one or more operators may be used to create the inertially focused state of FIG. 6B. The fluid flow is then subject to another program (program #1) to create the cross sectional flow distribution seen in FIG. 6C. As seen in FIG. 6C, the particles 20 are now contained within the reaction buffer 30, while the fluid 22 that previously contained the particles 20 is separated therefrom. The wash buffer 32 is also seen as separated from the particles 20. In this condition, the particles 20 react with the reaction buffer 30. The incubation time of the particles 20 within the reaction buffer 30 may be adjusted or tuned by altering the length of the channel.

FIG. 6D illustrates a cross-sectional view of the microfluidic channel 12 after undergoing another program (program #2). The program may include, as described herein, one or more operators selected from a library. As seen in FIG. 6D, the particles 20 are now contained within the wash buffer 32. The reaction buffer 30 is thus swapped out in favor of the wash buffer 32. The initial fluid 22 containing the particles 20 is also restricted to one area of the microfluidic channel 12. FIG. 6E illustrate the downstream portion of the microfluidic channel 12 with three outlets 34, 36, and 38. A first outlet 34 is used to capture the fluid 22 that initially carried the particles 20. The particles 20 in the wash buffer 32 are collected in the second outlet 36 while the third outlet 38 captures the reaction buffer 30. This particular configuration may be used for antibody staining of particles 20 (e.g., cells), chemical functionalization, solid-phase synthesis reactions and the like.

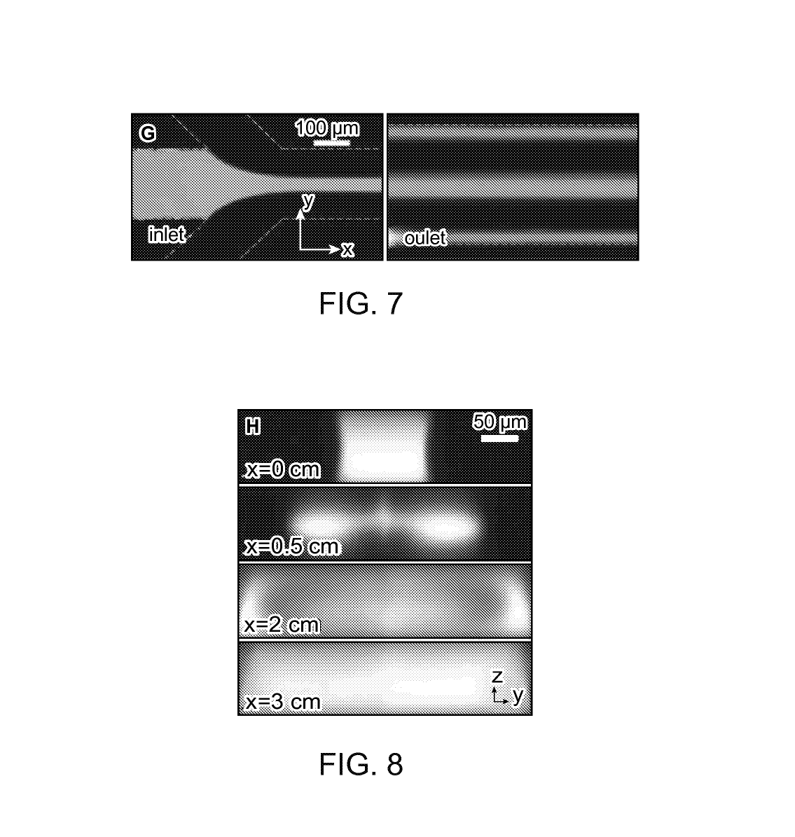

The microfluidic platform and methods may also be used to design system for splitting of streams. Stream splitting is useful to maximize the interface or contact between two or more streams. This can be useful in parallelization of screening applications like flow cytometry. The formation of such interfaces may also be used for liquid-liquid extraction. FIG. 7 illustrates the flow profile of such an embodiment for both the inlet and the outlet. As seen in FIG. 7, a single stream is split into three different streams.

In still another exemplary use, the microfluidic platform may be used in microfluidic mixing of fluids. The strong deformations create a semi-helical motion in the flow (for the simplest case of centrally located pillars), which can be used to enhance mixing at high Peclet numbers. FIG. 8 illustrates cross-sectional confocal views of microfluidic mixing of a stream. In this case full mixing is achieved at high flow rate (Pe=O(10⁵)) in less than 3 cm after contact with only a few pillars. There is no need for curved channels or channels with herringbone grooves. Rather, mixing can be added by the addition of operators like pillars to a straight microfluidic channel 12.

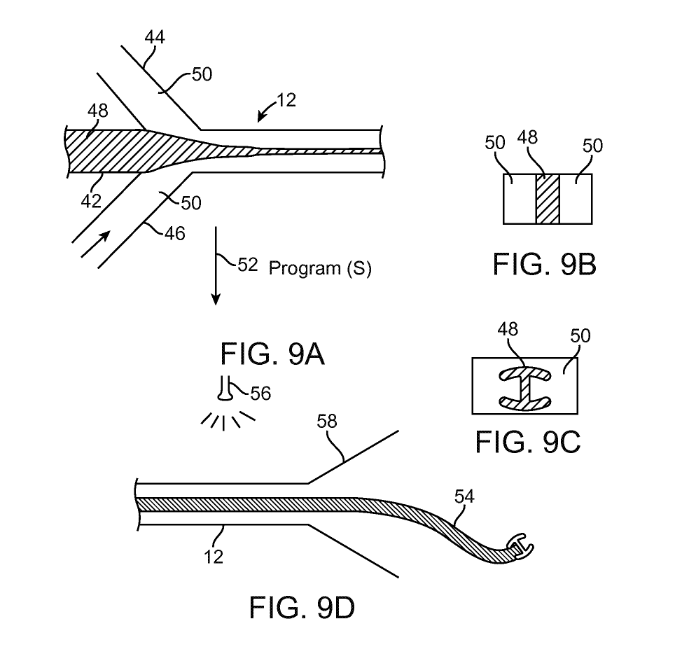

The ability to program fluid flows in channels, particularly controlling the cross-sectional shape, rotation, and motion of moving fluid streams introduces a fundamental new capability that can be used to in a variety of applications. For instance, by controlling the cross-sectional shape of a monomer stream, this platform enables the manufacture of new classes of polymerized fibers within specifically engineered interactions such as interlocking capability of self-assembly (e.g., VELCRO like ability). FIG. 9A illustrates a microfluidic channel 12 that is used to manufacture a polymerized fiber having custom made cross-sectional shape. The device includes three inlets 42, 44, 46 with a central inlet 42 containing a polymer precursor 48. The polymer precursor 48 could be a PEG-based precursor such as PEG diacrylate that can be photo-activated although other materials such as hydrogels may also be used. The outer two inlets 44, 46 each contain a sheathing fluid 50 that are of similar viscosity and density to the polymer precursor 48. For example, the sheathing fluid 50 may include PEG. FIG. 9B illustrates the cross-sectional view of the polymer precursor 48 centrally aligned within the sheath fluid 50. The fluid is then programmed (as illustrated by arrow 52) to change its cross-sectional shape by using the library of operators (e.g., pillar operators) as described herein. FIG. 9C illustrates the cross-sectional shape of the polymer precursor 48 after passing through the programmed area of the microfluidic channel 12. The cross-sectional shape is in the form of an “I,” although any cross-sectional pattern capable of being produced can be used.

Next, as seen in FIG. 9D, the polymer precursor 48, after being shaped into the desired shape, undergoes polymerization to create a fiber 54 having the cross-sectional that was shaped within the microfluidic channel 12. As seen in FIG. 9D, polymerization is activated upon exposure to light (e.g., UV light) using light source 56. It should be understood, however, that other polymer activators may also be used. For example, polymerization may be activated using chemicals, thermal exposure, or the like. The outlet channel 58 may be optionally expanded to slow down the flow during this exposure step.

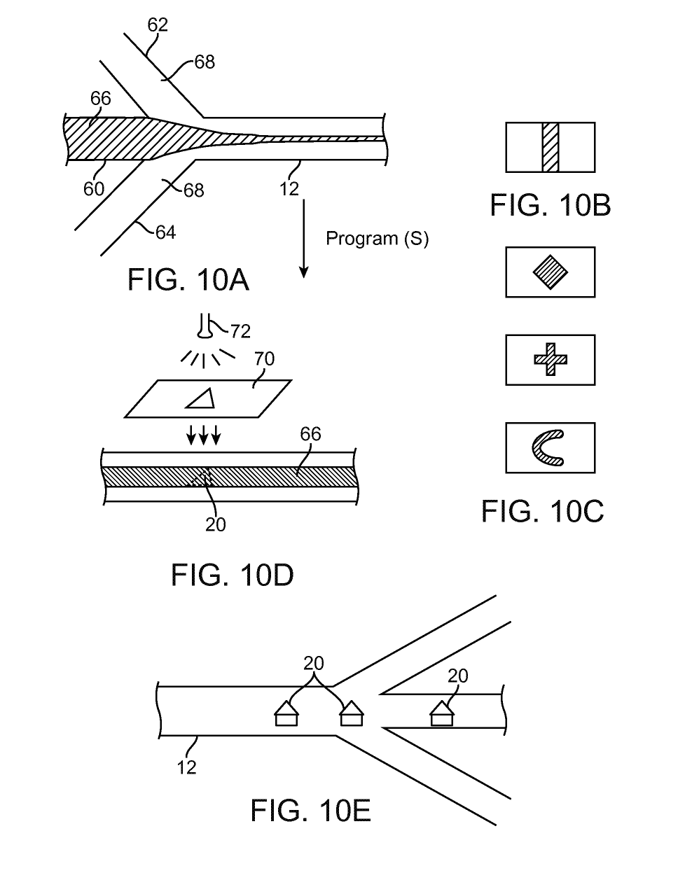

FIG. 10A illustrates a similar technique that is used to generate three-dimensional shaped particles 20. In this embodiment, a microfluidic channel 12 is provided with three inlets 60, 62, 64. A first middle inlet 60 is used to carry a precursor material 66. The two outer inlets 62, 64 are used to create a sheath flow around the precursor material 66 using a sheath fluid 68 (similar viscosity as precursor material 66). FIG. 10B illustrates a cross-sectional representation of the focused precursor material 66. The precursor material 66 is then run through one or more programs to alter the cross-sectional shape of the precursor material 66 by using, for example, pillar operators. Three representative examples of different shapes are seen in FIG. 10C. Once the desired fluid shape is created, the precursor material 66 is then activated to solidify and form a polymer using a mask 70 interposed between a light source 72 and the precursor. For example, as seen in FIG. 10D, light (e.g., UV light) is passed through a mask 70 that is interposed between the microfluidic channel 12 and a source of light 72. Light passing through the mask 70 then activates or polymerizes a portion of the precursor material 66 to form a three dimensional particle 20 as seen in FIG. 10E. The three dimensional particles 20 are then collected “off chip.” Complex three dimensional shaped particles 20 can be formed. The 3D shape is defined by the extrusion of the mask shape (from the light) onto the pre-shaped precursor material 66. Again, while light is described herein as the initiator of polymerization other modes of initiation could also work such as thermal or even chemical exposure.

The three dimensional shaped particle 20 can interact with other particles that are separately created by the device or otherwise flowed through the microfluidic channel 12 allowing for 3D recognition and self-assembly. The created particle 20 could have a high surface to volume ratio useful for collecting analytes or delivering materials.

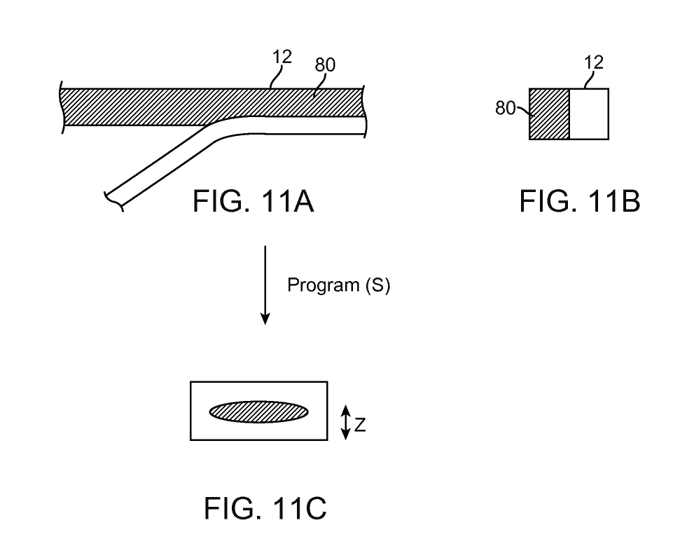

The microfluidic channel 12 can also be used to create focused fluid streams for optical excitation and/or interrogation. Inertial focusing can be used to align particles or a particular fluid stream containing other components at a particular location or locations within a microfluidic channel 12. The fluid can be focused at the same z-plane for optical interrogation such as flow cytometry. FIG. 11A illustrates a microfluidic channel 12 that is used to create focused fluid stream for subsequent optical interrogation such as flow cytometry. FIG. 11B illustrates the initially established sheath flow cross section. The fluid stream of interest 80 is shown in one half of the microfluidic channel 12. In order to focus the fluid, the fluid is run through a program that is made of one or more operators that focuses the stream of interest 80 at a common z-plane which can be subsequently interrogated. FIG. 11C illustrates the focused stream 80 after being subject to the program. Additionally, programming a variety of cross-sectional lens shapes with a fluid of separate index of refraction can be used for optofluidic control and sensing.

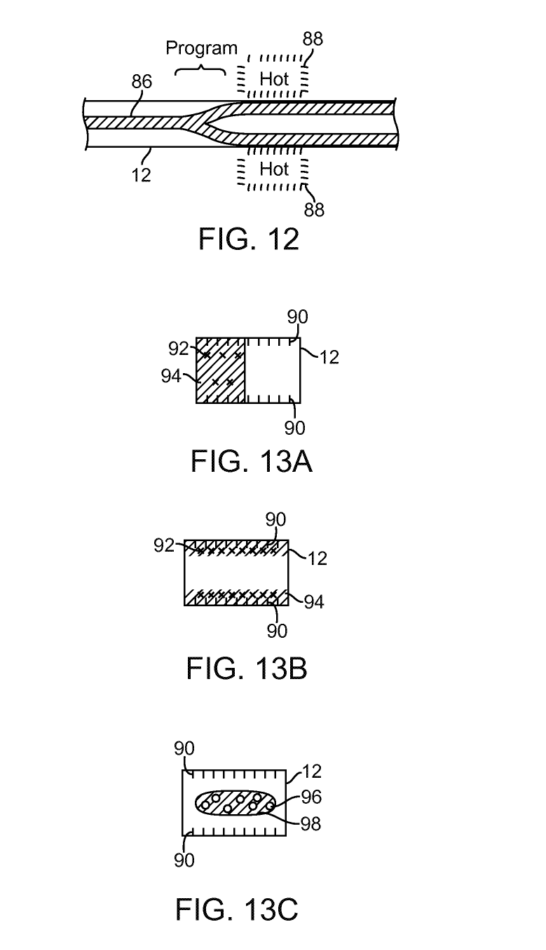

The method and concepts herein can be used to drive fluid from the cold side of a channel to hot spots in a controlled fashion. Heat transfer can be improved drastically when fluid can quickly be moved to and away from channel surfaces to maximize temperature gradients. FIG. 12 illustrates a microfluidic channel 12 having a cooling fluid 86 passing through a central region. The two opposing sides of the microfluidic channel 12 have hot regions or spots 88. In order to better transfer heat from these regions, the cooling fluid 86 is passed through a program of one or more operators to move the cooling fluid 86 adjacent to the hot regions. The cooling fluid 86 is then able to draw or wick away heat to improve heat transfer. In the illustrated embodiment, the program splits the cooling fluid 86 to two different streams but it should be understood that that the cooling fluid 86 need not necessarily be split. For example, only one side of the microfluidic channel 12 may contain a hot spot or region in which case the cooling fluid 86 need only be moved laterally toward one side of the microfluidic channel 12.

In a manner similar to the embodiment of FIG. 12, there may be instances where a fluid stream is needed to be moved closer to a surface. For example, dyes or reactants may be needed at a surface to enhance a given reaction. As another example, by bringing target molecules close to a binding surface, this will slow their respective velocities near the surface and enhance the probability of contact and consequently can improve capture efficiency. Other reactions need limited or controlled exposure to a surface and flow can be established within a microfluidic channel 12 to target exposure to a surface for a particular amount of time. Conversely, there may be a need to drive a fluid stream away from a surface. For example, one may want to prevent non-specific binding of species or prevent the adhesion of proteins or other targets to a surface that may promote fouling. In another example, reaction products or byproducts may be produced at or near a surface. Flow programming can be used to remove or elute these constituents.

FIG. 13A illustrates the cross-sectional view of a microfluidic channel 12 that includes upper and lower surfaces that having binding molecules or species 90 disposed thereon. The binding molecules or species 90 bind selectively to targets 92 contained with a fluid 94. Targets may include cells, virus particles, biomolecules, chemicals, antibodies, antigens, nucleic acids, proteins, and the like. As seen in FIG. 13A, about half of the binding molecules or species 90 are not exposed to the fluid 94 containing the targets 92. Fluid programming can be performed as illustrated in the cross-sectional view of FIG. 13B such that the entire upper and lower surfaces having binding molecules or species 90 are exposed to the fluid 94 containing the targets 92. Conversely, FIG. 13C illustrates a situation where non-specific targets 96 contained within a fluid 98 are purposely kept away from the upper and lower walls to prevent a reaction or non-specific absorption.

Fluid programming may also be used to minimize Taylor dispersion. Taylor dispersion is an effect in fluid mechanics in which a shear flow can increase the effective diffusivity of a species. Taylor dispersion acts to smear out the concentration distribution in the direction of the flow. By preventing Taylor dispersion, a more uniform plug can be created within a microfluidic channel for better control of concentration, time of reaction and uniform velocity. For example, material that is collected from a surface at a specific time or material in a bulk flow at a specific time will tend to spread out in the direction of fluid flow as the fluid plug of interest passes along the channel. Fluid programming can be performed to bring that flow plug to the same velocity regions of flow within a channel to thereby minimize any Taylor dispersion. Downstream analysis can then be conducted without any blurring of the response due to Taylor dispersion.

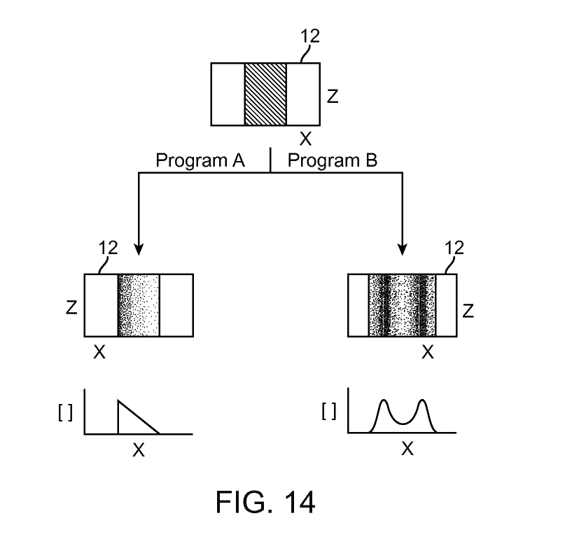

Fluid programming can also create gradients of species or molecules with various shapes. Current methods for gradient generation are either complex designs that have parallelized networks and high fluidic resistance, or are done by macro-scale deposition of solutions which offers very limited control over the gradients. Operators such as pillars can be formed easily on simpler platforms and offer less fluidic resistance while deterministically defining the gradient shape and location to offer superior control. FIG. 14 illustrates a cross sectional image (top) of a plug of fluid having a uniform gradient. FIG. 14 further illustrates two different programs (A and B) that create, respectively, different gradients of the plug of fluid within the microfluidic channel 12. Program A creates a linear gradient as seen by the concentration graph illustrated below the post-program cross-sectional image. Program B creates a different gradient having two localized maxima as seen by the respective concentration graph. This platform, can potentially create multiplex gradient systems of multiple species in parallel or series for studies such as the study of effect of gradients on neural cells and their communication.

An advantage of the programming method and devices described herein is that they can be fabricated using standard two-dimensional (i.e., single layer) fabrication techniques such as PDMS replica molding with a single mask, injection molding, hot embossing, laser cutting, or machining. This decreases the time and cost of fabrication significantly. Further, there is no need for complex external setups to induce motion or gradients in the flow fields as opposed to prior art methods that use active control (e.g., electrodes). This translates to fewer components and decreases the possibility of device failure or malfunction which greatly enhances the robustness and reliability of the platform.

One important feature of pillar-based systems is operation over a wide range of flow rates and Reynolds numbers (Re˜6-60) with a similar scale of lateral fluid deformation, which introduces a number of advantages. First, because the system has low sensitivity with flow rate, the final product will be able to repeat its operation for a relatively large range of flow rates, thus having a large tolerance. Such advantage makes it more reliable and less costly, since the more sensitive the system, the more controlled it should be, and the more controlled it is the more costly it would be. Second, this enables the system to work over a wide range of relevant interfacial time-constants, which could be especially useful for chemical/biological applications with various kinetics. Also, this uniform operation over a large range of flow rates allows sequential assembly of post/pillar patterns within different overall channel dimensions, i.e. where the fluid has sped up or slowed substantially, without detailed simulation. Alternatively, the library can be expanded to contain operators calculated at different flow rates to address expanding or splitting channels and programming at different Reynolds numbers or in different modes of operation.

As explained herein, the system can exhibit different modes of operation depending on the system conditions (Re, post diameter (D/w), and channel aspect ratio (h/w)). This means that at high flow rates the flow regime can be different and the number of secondary flows can be doubled in the channel. The high flow rates that can be used with the system also translate into very high throughput.

While embodiments of the present invention have been shown and described, various modifications may be made without departing from the scope of the present invention. The invention, therefore, should not be limited, except to the following claims, and their equivalents.

1. A method of programming flow within a channel comprising:
selecting a plurality of operators from a library, each of the plurality of operators from the library having a known net secondary fluid affect;
creating a program from the plurality of selected operators; and
manufacturing a channel having formed therein the program of selected operators.

2. The method of claim 1, wherein the plurality of operators comprise posts.

3. The method of claim 2, wherein the posts span the entirety of the channel.

4. The method of claim 2, wherein the posts span between about 10% to about 90% of the channel.

5. The method of claim 2, wherein the plurality of operators comprise slanted grooves.

6. The method of claim 2, wherein the posts have uniform cross-sections along their respective lengths.

7. The method of claim 2, wherein the posts have non-uniform cross-sections along their respective lengths.

8. The method of claim 1, wherein the plurality of operators comprise at least one protuberance.

9. The method of claim 1, wherein the channel and operators are manufactured in a polymer or glass.

10. The method of claim 1, further comprising flowing a fluid through the channel.

11. The method of claim 1, wherein the library comprises at least four operators.

12. A device comprising:
a channel having at least one intersecting sheath fluid channel at an upstream location; and
a plurality of different operators disposed within the channel at a downstream location, each operator comprising one or more protuberances having a known net secondary fluid affect, each of the plurality of operators being separated from one another along a length of the channel.

13. The device of claim 12, wherein the protuberances comprise at least one of posts, steps, and grooves.

14. The device of claim 12, wherein the protuberances comprise posts, and adjacent operators within the channel are separated by a distance of between about 4 to about 15 post diameters.

15. A method of exchanging fluids around particles within a channel comprising:
initiating sheath flow within a channel, wherein the particles are contained in a carrier fluid and absent from a sheathing fluid; and
passing the particles through a program comprising a plurality of operators disposed within the channel configured to alter the flow around the particles such that the particles are contained within the sheathing fluid and not contained in the carrier fluid.

16. The method of claim 15, wherein the sheathing fluid comprises first and second sheathing fluids.

17. The method of claim 16, wherein the particles are contained in the first sheathing fluid.

18. The method of claim 17, further comprising passing the particles through a program comprising a plurality of operators disposed within the channel configured to alter the flow to around the particles such that the particles are subsequently contained within the second sheathing fluid and not contained in the first sheathing fluid or the carrier fluid.

19-29. (canceled)
